(19) United States
(12) Patent Application Publication
(10) Pub. No.: US 2003/0032459 A1
(43) Pub. Date: Feb. 13, 2003

(54) Hands-free kit for mobile phones

(76) Inventor: Seok-Ki Kim, Goyang City (KR)

Correspondence Address: BLUMENFELD, KAPLAN & SANDWEISS, P.C., 168 NORTH MERAMEC, 4TH FLOOR, CLAYTON, MO, 63105-3763, US

(21) Appl. No.: 09/683,519

(22) Filed: Jan. 11, 2002

(30) Foreign Application Priority Data
Jun. 10, 2001 (KR) 20-2001-0031602

(51) Int. Cl. H04B 1/38

(52) U.S. Cl. 455/569; 455/557

(57) ABSTRACT

Disclosed herein is a hands-free kit for mobile phones used while being mounted on a cup holder of an automobile. The hands-free kit includes a cup-shaped body, a speaker unit and a remote controller. The cup-shaped body is provided on its front portion with a power light emitting diode lamp for displaying an ON/OFF state of a mobile phone, a microphone for receiving and amplifying voice from a user and a radio receiver for receiving signals from the remote controller and forwarding them to the body, on its rear portion with a phone connector for electrically connecting the body to the mobile phone and a lighter jack connector for receiving power from the automobile, in its interior with an electronic circuit, and on its bottom with a through hole for preventing debris from piling up on the bottom. The speaker unit serves to amplify and output voice from the mobile phone, and is provided with a flexible boom for connecting the speaker unit to the body and allowing the speaker unit to be freely rotated.

### BACKGROUND OF INVENTION

1. Field of the Invention

The present invention relates generally to a hands-free kit for mobile phones, and more particularly to a hands-free kit for mobile phones, which is capable of being mounted on a cup holder of an automobile, controlling a mobile phone using a remote controller attached to a steering wheel and freely adjusting the direction and position of its speaker.

2. Description of the Prior Art

With the development of wireless communication technology, the number of users of mobile phones is explosively increased. As a result, as users utilize mobile phones while driving cars, the utilization of mobile phones frequently causes traffic accidents. Currently, in order to prevent traffic accidents due to the utilization of mobile phones while driving, it is prohibited by law to make phone calls with holding mobile phones with hands while driving, and fines are imposed on users making phone calls while holding mobile phones with hands while driving.

Accordingly, drivers usually mount hands-free kits on their automobiles so that they can make phone calls without holding mobile phone with their hands. In general, conventional hands-free kits are mounted on automobiles by forming boltholesthrough the dashboards of the automobiles and fastening the hands-free kits onto the dashboards with bolts inserted into the boltholes, or attaching the hands-free kits onto the dashboards of the automobiles using adhesive tapes.

However, the conventional hands-free kits are disadvantageous in that the dashboards of automobiles are damaged by the bolt holes or the hands-free kits can be easily removed from the dashboards by long term use, the moving of the hands-free kits from one automobile to another is very difficult, and the speakers of the hands-free kits cannot be freely adjusted.

### SUMMARY OF INVENTION

Accordingly, the present invention has been made keeping in mind the above problems occurring in the prior art, and an object of the present invention is to provide a hands-free kit for mobile phones, which is capable of being mounted on a cup holder of an automobile, controlling a mobile phone using a remote controller attached to a steering wheel and freely adjusting the direction and position of its speaker, such that it can be easily mounted on an automobile, can be easily removed from one automobile to be mounted on another, does not damage an automobile when it is mounted on the automobile, can allow a user to safely drive an automobile, can clearly output voice from a mobile phone and can be applied to a variety of mobile phones.

In order to accomplish the above object, the present invention provides a hands-free kit for mobile phones used while being mounted on a cup holder of an automobile, comprising: a cup-shaped body provided on its front portion with a power light emitting diode lamp for displaying an ON/OFF state of a mobile phone, a microphone for receiving and amplifying voice from a user and a radio receiver for receiving signals from the remote controller and forwarding them to the body, on its rear portion with a phone connector for electrically connecting the body to the mobile phone and a lighter jack connector for receiving power from the automobile, in its interior with an electronic circuit, and on its bottom with a through hole for preventing debris from piling up on the bottom, wherein its top periphery is elliptically shaped and slanted, and a wall of its cavity is formed of soft material; a speaker unit for amplifying and outputting voice from the mobile phone, the speaker unit being provided with a flexible boom for connecting the speaker unit to the body and allowing the speaker unit to be freely rotated; and a remote controller provided with a keypad for remotely controlling a mobile phone, the keypad being attached to a steering wheel of the automobile.

### BRIEF DESCRIPTION OF DRAWINGS

The above and other objects, features and other advantages of the present invention will be more clearly understood from the following detailed description taken in conjunction with the accompanying drawings, in which:

FIG. 1 is a perspective view showing a hands-free kit for mobile phones in accordance with the present invention;

FIG. 2 is a longitudinal sectional view showing the hands-free set;

FIG. 3 is a perspective view showing the hands-free set with a mobile phone held by its body; and

FIG. 4 is a perspective view showing the use of the hands-free kit mounted on the cup holder of an automobile.

### DETAILED DESCRIPTION

A hands-free kit for mobile phones in accordance with the present invention is described in detail with reference to the accompanying drawings below.

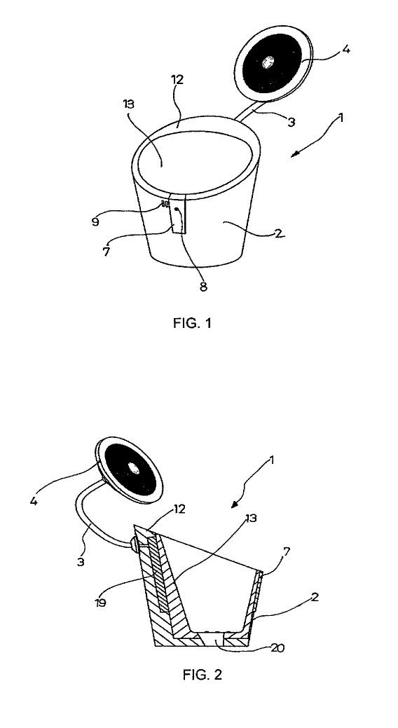

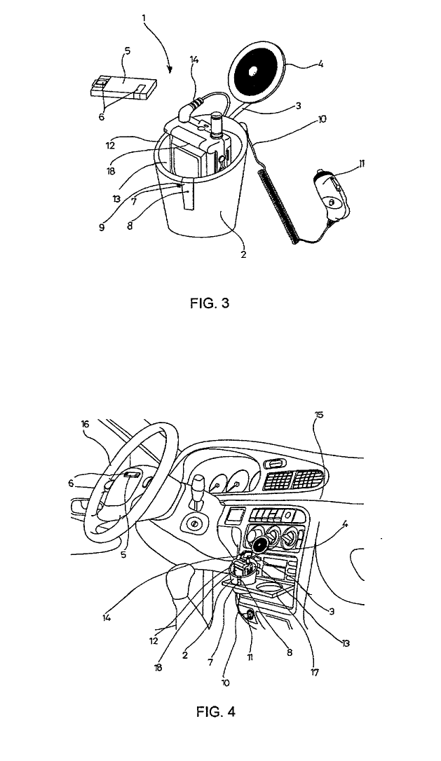

FIG. 1 is a perspective view showing a hands-free kit for mobile phones in accordance with the present invention. FIG. 2 is a longitudinal sectional view showing the hands-free set. FIG. 3 is a perspective view showing the hands-free set with a mobile phone held by its body. FIG. 4 is a perspective view showing the use of the hands-free kit mounted on the cup holder of an automobile.

Currently, a retractable cup holder 17 is commonly mounted on a dashboard 15 of an automobile at a position that a driver can easily reach, so as to increase a users convenience. The cup holder 17 is generally provided with one or more openings and is projected toward the user to hold cups or beverage containers.

The hands-free kit 1 for mobile phones can be held by the cup holder 17 with a body 2 of the hands-free kit 1 inserted into an opening of the cup holder 17.

The hands-free kit 17 of the present invention is generally comprised of a cup-shaped body 2, a speaker unit 4 for amplifying and outputting voice from a mobile phone 18, and a remote controller 5 for remotely controlling the mobile phone 18.

The top periphery 12 of the body 2 is elliptically shaped and slanted such that the mobile phone 18 is easily seen while being accommodated in the cavity 13 of the body 2.

The body 2 is provided on its front portion with a power light emitting diode (LED) lamp 7 for displaying an ON/OFF state of the mobile phone 18, a microphone 9 for receiving and amplifying voice from a user, and a radio receiver 8 for receiving signals from the remote controller 5 and forwarding them to the body 2.

The body 2 is provided on its rear portion with a phone connector 14 for electrically connecting the body 2 to the mobile phone 18 and a lighter jack connector 11 for receiving power. Power is supplied from the battery of an automobile to the hands-free kit 1 including the body 2 through a lighter jack (not shown) and the lighter jack connector 11.

Additionally, the body 2 is provided in its interior with a circuit to control the reception, retransmission and volume of the mobile phone 18 and conversion to hands-free function.

The cavity 13 of the body 2 allows any of a variety of mobile phones to be inserted into the body 2. Accordingly, the mobile phone 18 is usable, if the phone connector 14 of the hands-free kit 1 is connected to the mobile phone while the mobile phone 18 is simply accommodated in the cavity 13 of the body 2.

The wall of the cavity 13 of the body 2 can be formed of soft material to prevent the mobile phone 18 from being damaged by the vibration of an automobile. The bottom of the body 2 is provided with a through hole 20 to prevent debris from piling up on the bottom of the body 2.

The speaker unit 4 is provided with a flexible boom 2 to connect the speaker unit 4 to the body 1. Accordingly, the position and direction of the speaker unit 4 can be adjusted to desirably output voice using the flexible boom 3.

The remote controller 5 is provided with a keypad 6 to remotely control the reception, retransmission and volume of the mobile phone 18 and conversion to hands-free function while being attached to the hone of the steering wheel of an automobile by an adhesive tape or the like. Accordingly, a user can remotely and wirelessly control the mobile phone 18 while looking forward while driving, so he can make a phone call safely and conveniently.

As described above, the present invention provides a hands-free kit for mobile phones, which is capable of being mounted on a cup holder of an automobile, controlling a mobile phone using a remote controller attached to a steering wheel, and freely adjusting the direction and position of its speaker. Accordingly, it can be easily mounted on an automobile, can be easily removed from one automobile to be mounted on another, does not damage an automobile when it is mounted on the automobile, can allow a user to safely drive an automobile, can clearly output voice from a mobile phone, and can be applied to a variety of mobile phones.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A hands-free kit for mobile phones used while being mounted on a cup holder of an automobile, comprising:
a cup-shaped body provided on its front portion with a power light emitting diode lamp for displaying an ON/OFF state of a mobile phone, a microphone for receiving and amplifying voice from a user and a radio receiver for receiving signals from the remote controller and forwarding them to the body, on its rear portion with a phone connector for electrically connecting the body to the mobile phone and a lighter jack connector for receiving power from the automobile, in its interior with an electronic circuit, and on its bottom with a through hole for preventing debris from piling up on the bottom, wherein its top periphery is elliptically shaped and slanted, and a wall of its cavity is formed of soft material;
a speaker unit for amplifying and outputting voice from the mobile phone, the speaker unit being provided with a flexible boom for connecting the speaker unit to the body and allowing the speaker unit to be freely rotated; and
a remote controller provided with a keypad for remotely controlling a mobile phone, the keypad being attached to a steering wheel of the automobile.
